(19) United States
(12) Patent Application Publication
(10) Pub. No.: US 2022/0375062 A1
(43) Pub. Date: Nov. 24, 2022

(54) PRODUCING METHOD OF POWER STORAGE DEVICE

(71) Applicant: Prime Planet Energy & Solutions, Inc., Tokyo (JP)

(72) Inventor: Yasuaki OHTSUKI, Toyota-shi (JP)

(21) Appl. No.: 17/726,475

(22) Filed: Apr. 21, 2022

(30) Foreign Application Priority Data
May 20, 2021 (JP) 2021-085195

(51) Int. Cl. G06T 7/00

(52) U.S. Cl. CPC G06T 7/0004

(57) ABSTRACT

A producing method of a power storage device exteriorly formed with a device case includes producing an uninspected power storage device and appearance inspecting. The appearance inspecting includes irradiating an inspection light to a to-be-inspected region, photographing diffuse reflection lights of the inspection light, detecting an appearance of the to-be-inspected region of the device case, and determining propriety of the appearance of the detected to-be-inspected region. The appearance inspecting further includes detection enabling of applying a detection enabling process for allowing detection of the appearance to a difficult-to-detect region which is difficult to detect the appearance due to high glossiness or a possible difficult-to-detect region.

### CROSS-REFERENCE TO RELATED APPLICATIONS

This application is based upon and claims the benefit of priority from the prior Japanese Patent Application No. 2021-085195, filed May 20, 2021, the entire contents of which are incorporated herein by reference.

### BACKGROUND

### Technical Field

The present disclosure relates to a producing method of a power storage device.

### Related Art

Heretofore, in producing a power storage device, a produced uninspected power storage device is performed with an appearance inspection for determining presence or absence of deformation and flaws. As a conventional art related to an apparatus and a method used for this appearance inspection, for example, JP 2005-265818A is given.

This JP 2005-265818A describes a glossy surface inspection device including a light projecting unit to irradiate an illumination light beam to a glossy surface, a camera to photograph a reflection light (a specular reflection light) of the illumination light beam, an image processing member, and a determination member for examining surface defects in a dry-cell battery, beverages, a liquid crystal panel, and others.

### SUMMARY

### Technical Problems

in most cases, however, a surface of a device case constituting an appearance of a power storage device is not a glossy surface but a non-glossy surface such as a surface applied with stain finish, hairline finish, and scratch finish.

For inspecting the non-glossy surface, the appearance inspection for the power storage device is to be performed to inspect each of presence or absence and a size of bulges in an entire region to be inspected, presence or absence of a partial dent and a shape thereof, and presence or absence of incisional flaws which are partially made. For the inspection, there is performed a so-called light-plane-intersecting method of performing the appearance inspection for the power storage device in the region to be inspected by irradiating and moving an inspection light (a laser beam or the like) of a spot shape or of a line shape on the region to be inspected and photographing diffuse reflection lights from the irradiated portion.

However, there has been confirmed a case that a part of a device case of a power storage device became a region difficult to be detected its appearance by the above-mentioned diffuse reflection lights. This is because irradiation of the inspection light on a region with high glossiness generates the specular reflection light with high luminous intensity while the intensity of the diffuse reflection lights used for photographing decreases, so that the appearance inspection fails and an inspection accuracy gets degraded. The present disclosure has been made in view of the above circumstances and has a purpose of providing a power storage device that has been inspected its appearance in an appropriate manner.

### Means of Solving the Problems

(1) One aspect of the present disclosure for solving the above problem is A producing method of a power storage device exteriorly formed with a device case, including: producing an uninspected power storage device; and appearance inspecting of inspecting the uninspected power storage device, wherein the appearance inspecting comprises: detecting which includes irradiating an inspection light on the to-be-inspected region, photographing diffuse reflection lights of the inspection light, and checking an appearance of the to-be-inspected region of a case surface of the device case, and determining propriety of the detected appearance of the to-be-inspected region, the appearance inspecting further includes detection enabling of performing a detection enabling process prior to the detecting to enable detection of the appearance on at least any one in the to-be-inspected region of the device case of: a difficult-to-detect region which is difficult to be detected its appearance due to high glossiness; and a possible difficult-to-detect region which has a possibility of becoming the difficult-to-detect region.

In this producing method of the power storage device, prior to detecting the appearance of the entire region to be inspected, the detection enabling process is performed on the difficult-to-detect region or the possible difficult-to-detect region of the region to he inspected so that detection of the appearance can be performed. Accordingly, the appearance of the entire region to he inspected can be appropriately detected, and further, the power storage device which has been appropriately inspected its appearance can be produced.

Herein, as a “power storage device,” for example, there are given a secondary battery such as a lithium-ion secondary battery, a capacitor such as an electric double-layer capacitor and a lithium-ion capacitor. Further, a “uninspected power storage device” represents a power storage device which has not yet finished its completion inspection including the appearance inspection after producing. As a shape of the power storage device (the uninspected power storage device), a rectangular parallel-piped box-like shape and a cylindrical shape can be exemplified.

Further, as a shape of the “device case” forming an exterior of the power storage device, there are given a rectangular parallel-piped box-like shape and a cylindrical shape as examples. Material of the “device case” may be any material that can be used for the exterior of the power storage device, and metal such as aluminum, duralumin, stainless-steel, and copper alloy, CFRP (carbon fiber reinforced plastics), GFRP (glass fiber reinforced plastics), the ones plated with these CFRP and GFRP, and a laminated film in which metal foil and resin film are laminated may be given as examples.

The “to-be-inspected region” of the case surface of the device case may be, when the power storage device (the device case) is of the rectangular parallel-piped box-like shape, each one of six rectangular side faces (an upper face, a bottom face, long side faces, and short side faces), or may he a part of the side face (for example, when the device case is formed of a lid member constituting the upper face and a case body of a recessed shape constituting the other five side faces, a portion of the long side face on an upper face side (on an opening edge side) and a portion of the long side face on a side of the short side face where is close to a ridge formed by the long side face and the short side face). Further, when the power storage device (the device case) is of a cylindrical shape, for example, the “to-be inspected region” may be each one of the upper face, the bottom face, and the cylindrical face, or may be a part of them (for example, when the device case is formed of the lid member constituting the upper face and the case body member of a recessed shape constituting the bottom face and the cylindrical face, a portion of the upper-face side (the opening edge side) of the cylindrical face),

The “inspection light” to be irradiated on the to-be-inspected region may be adopted from a spot light giving a dot-like irradiated portion, a line light giving a linear irradiated portion, a planar light giving the irradiated portion expanding rectangularly or circularly, and others. When the spot light is to be used, this spot light may be scanned in dual directions intersecting each other to irradiate the spot light on the entire range including the to-be-inspected region. When the linear line light is to be used, this line light may be scanned in the direction orthogonal to an extending direction of this line light to irradiate the line light on the entire range including the to-be-inspected region. When the planar light is to be used, this planar light may be irradiated all at once on the entire range including the to-be-inspected region or may be irradiated by scanning on the entire range including the to-be-inspected region.

The “glossiness” is an index indicating how glossy the surface is. As this index, a luminous intensity ratio of the incident light and the specular reflection light (the regular reflection light) when the light is being irradiated on the irradiation portion of the to-be-inspected region, specifically, a specular glossiness prescribed in the “specular glossiness-Methods of measurement” of HS Z 8741-1997, for example, a specular glossiness Gs of 60 degrees (60°) can be used.

The “difficult-to-detect region” is a region which is difficult to be detected its appearance by the diffuse reflection lights of the inspection light because the region has high glossiness, This difficult-to-detect region is formed in a manner that a specified surface portion of a case surface of the device case is strongly rubbed against a surface of a metal die to get smoothened and formed in producing of the device case, or that the device case is strongly rubbed with a conveyance device or an assembling device while the device case is being conveyed or held in producing of the power storage device. However, a certain portion of the case surface of the device case does not always become the difficult-to-detect region. For example, there may be chronological changes in presence or absence, occurrence location, occurrence possibility of the difficult-to-detect region since the metal die gets abraded by producing of numerous device cases, leading to high glossiness in a specified portion of the device case.

On the other hand, the “possible difficult-to-detect region” is a region that has a possibility of becoming the above-mentioned “difficult-to-detect region” of the to-be-inspected region, namely, a region which could become the “difficult-to-detect region.” When a device case and a power storage device are to be produced, the difficult-to-detect region is not always generated on a specified portion of the case surface commonly in a plurality of the device cases, As mentioned above, abrasion of the metal die could cause chronological changes in presence or absence, the occurrence location, and occurrence possibility of the difficult-to-detect region. As a result of this, even if some portions have not become the difficult-to-detect region on the case surface at an earlier time of using the metal die, there are gradually generated the difficult-to-detect region in some cases as the abrasion of the metal die proceeds due to increase in production times of the device cases. In this case, some portions in some device cases do not become the difficult-to-detect regions, but the corresponding portions in some other device cases become the difficult-to-detect regions. The possible difficult-to-detect region is the region having this possibility of becoming the difficult-to-detect region.

The “detection enabling process” is a process to be applied to the difficult-to-detect region or the possible difficult-to-detect region in a manner that the glossiness of the subject region is made to be glossiness allowed to be detected its appearance by the diffuse reflection lights temporarily at least until performing the detection process or permanently so that the region that has been the difficult-to-detect region or the possible difficult-to-detect region is allowed to be detected its appearance.

A region to be processed (processing region) that has been carried out with the detection enabling process may be limited to the difficult-to-detect region or the possible difficult-to-detect region of the to-be-inspected region, but may be a region including the difficult-to-detect region or the possible difficult-to-detect region. Accordingly, this processing region may be a part of the to-be-inspected region including the difficult-to-detect region or the possible difficult-to-detect region or the entire to-be-inspected region, Furthermore, the processing region may be a region wider than the to-be-inspected region as long as it includes the to-be-inspected region.

As a specific method of the detection enabling process, there are given examples such as a method of generating a minute-droplets distributed layer in which minute droplets formed of volatile liquid such as water and organic solvent are dispersedly distributed by blowing cooling gas to the region to be processed in order to cause dew condensation or by spraying liquid in a mist shape, a method of forming a matte layer by applying matte paint or adhering fine powder to the region to be processed, and a method of roughening the surface of the processing region.

(2) The producing method of the power storage device described in the above (1), preferably, the detection enabling is, as the detection enabling process, to generate a minute-droplets distributed layer, in which minute droplets formed of volatile liquid are dispersedly distributed, in any one of the difficult-to-detect region and the possible difficult-to-detect region.

In this producing method of the power storage device, the difficult-to-detect region or the possible difficult-to-detect region is generated with the minute-droplets distributed layer, and thus in the detecting, the entire to-be-inspected region including the difficult-to-detect region or the possible difficult-to-detect region can be appropriately detected its appearance, so that propriety of the appearance of the to-be-inspected region can be appropriately judged.

Moreover, the minute-droplets distributed layer is formed of minute droplets of the volatile liquid, and thus the layer is volatilized and disappears, leaving nothing on the case surface of the device case. This layer accordingly has no influence on the appearance of the power storage device and handling of the power storage device thereafter.

A specific method of generating the “minute-droplets distributed layer” in the difficult-to-detect region or the possible difficult-to-detect region can be exemplified by blowing cooling gas to the difficult-to-detect region or the possible difficult-to-detect region to cool down the region so that the minute-droplets distributed layer in which the minute droplets are dispersedly distributed by dew condensation is generated. The cooling gas used for this method only has to be gas that can cool down the difficult-to-detect region or the possible difficult-to-detect region, and as examples, there are given liquefied propane gas, normal butane, isobutane, HFC-134a (tetrafluoroethane), carbon dioxide gas, liquefied gas such as compressed air, and high-pressure gas.

Further, another method can be exemplified as a method of spraying volatile liquid in a mist shape to the difficult-to-detect region or the possible difficult-to-detect region to generate the minute-droplets distributed layer. As the volatile liquid used for this method, there are given water, alcohol such as methanol, ethanol, and IPA, organic solvent such as acetone, and fluorine fluid such as Fluorinert™.

(3) The producing method of the power storage device described in the above (1), preferably, the detection enabling is, as the detection enabling process, to form a matted material layer in any one of the difficult-to-detect region and the possible difficult-to-detect region.

In this producing method of the power storage device, the matted material layer can be formed on the difficult-to-detect region or the possible difficult-to-detect region, and thus in the detecting, the entire to-be-inspected region can be detected its appearance and the propriety of the appearance of the to-be-inspected region can be appropriately judged.

As the method of forming the “matted material layer” on the difficult-to-detect region or the possible difficult-to-detect region, a method of applying matte paint on the difficult-to-detect region or the possible difficult-to-detect region can be exemplified. This method of applying the matted paint includes an air spray (an airbrush) and a gas spray jetting the paint with gas such as LPG, for example.

Further, a method of adhering fine powder to the difficult-to-detect region or the possible difficult-to-detect region can be exemplified. As the fine powder, there are given fine powder of zinc oxide powder, titanium oxide powder, alumina powder, silica powder, and others. The method of adhering these fine powder is, for example, to blow dispersion liquid in which the fine powder is dispersed in volatile solvent dissolved with binder and mixture powder of the fine powder and the binder by use of the air spray or the gas spray.

Herein, the matted material layer formed in the power storage device may be left formed in the power storage device as it is, or may be removed by providing a removing process after termination of the appearance inspecting.

(4) The producing method of the power storage device according to the above-mentioned (1), preferably the detection enabling is, as the detection enabling process, to apply roughening to any one of the difficult-to-detect region and the possible difficult-to-detect region.

In this producing method of the power storage device, the roughening the difficult-to-detect region or the possible difficult-to-detect region is performed, and thus the appearance of the to-be-inspected region can be appropriately detected in the detecting, so that the propriety of the appearance of the to-be-inspected region can he appropriately judged.

The “roughening” to roughen the difficult-to-detect region or the possible difficult-to-detect region represents a process of increasing a surface roughness of the difficult-to-detect region or the possible difficult-to-detect region. Specifically, there are given examples of grinding or abrading to grind or abrade the difficult-to-detect region and others by an abrasive cloth or a sponge containing abrasive material to generate friction marks and of blasting to blow sand, glass powder, and others.

### BRIEF DESCRIPTION OF THE DRAWINGS

FIG. 1 is a perspective view of a battery in an embodiment and first to third modified embodiments:

FIG. 2 is an explanatory view illustrating an appearance inspection to be performed to the battery in the embodiment and the first to third modified embodiments;

FIG. 3 is an explanatory view of an example of appearance data (appearance profile) obtained by performing the appearance inspection for the battery in the embodiment and the first to third modified embodiments in a case that the appearance data is normally obtained and that a flaw is found;

FIG. 4 is an explanatory view of an example of the appearance data (appearance profile) obtained by performing the appearance inspection for the battery in a case that the appearance data is not obtained normally;

FIG. 5 is an explanatory view of a difficult-to-detect region of the battery in the embodiment and the first to third modified of embodiments and a processing region of the battery in the third modified embodiment;

FIG. 6 is an explanatory view of the difficult-to-detect region, a possible difficult-to-detect region, and the processing region of the battery in the embodiment;

FIG. 7 is a flowchart of a producing method of the battery in the embodiment and the first modified embodiment;

FIG. 8 is an explanatory view of the difficult-to-detect region, the possible difficult-to-detect region, and the processing region of the battery in the first modified embodiment; and

FIG. 9 is a flowchart of the producing method of the battery in the second modified embodiment.

### DETAILED DESCRIPTION OF THE EXEMPLARY EMBODIMENTS

### Embodiment

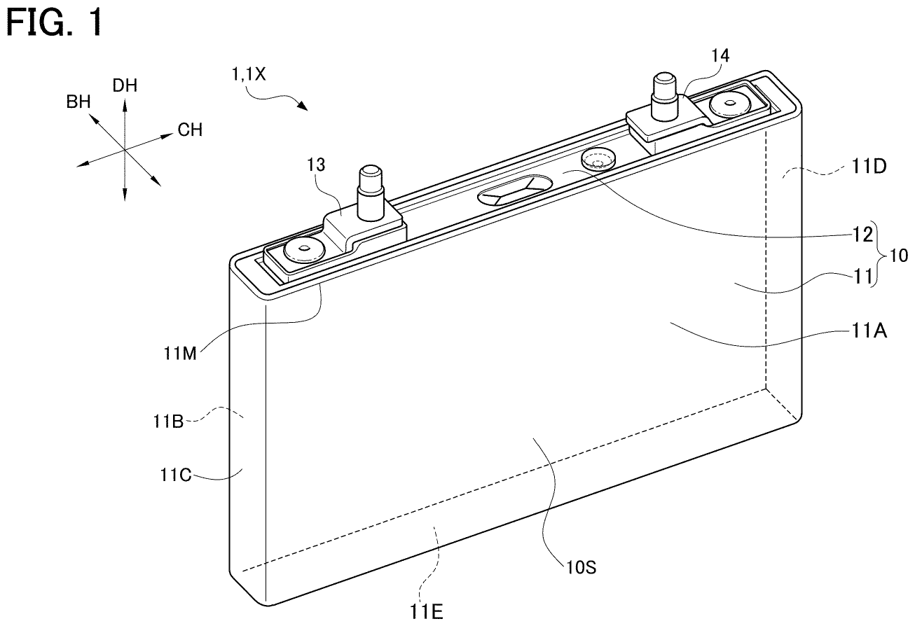

An embodiment exemplifying the present disclosure is explained below with reference to the accompanying drawings FIG. 1 to FIG. 7. The present embodiment adopts the present disclosure as producing a lithium-ion secondary battery (hereinafter, simply referred as a battery). Namely, in the present embodiment, a producing method of a battery 1 is exemplified as an embodiment of a producing method of a power storage device.

The battery 1 and an uninspected battery 1X (see FIG. 1), which is a battery to be inspected, according to the present embodiment is firstly explained. The uninspected. battery 1X is a battery that has not yet been completed an appearance inspection explained below, but its appearance and configuration are same as those of the battery 1 that has been completed its appearance inspection. The battery 1 (the uninspected battery 1X) is a rectangular battery configured such that an electrode body and an electrolyte (not shown) are accommodated in a rectangular parallel-piped battery case 10. The aluminum-made battery case 10 exteriorly forming the battery 1 is formed of a rectangular-cylindrical case body 11 of which an upper side is open and a bottom face is closed and an almost rectangular-plate-like lid member 12 that is overlapped on an opening edge 11M of the case body 11 to close an inside of the case body 11. The opening edge 11M of the case body 11 and the lid member 12 are laser-welded.

The case body 11 is integrally formed by an aluminum plate by a well-known drawing process using a metal die. Further, the lid member 12 is formed by punching an aluminum plate. This lid member 12 is fixed with a positive electrode terminal 13 communicated with a positive electrode plate (not shown) of the electrode body and a negative electrode terminal 14 communicated with a negative electrode plate (not shown) of the electrode body in the battery 1.

Further, three directions of a thickness direction BH, a width direction CH, and a height direction DH which are orthogonally intersecting one another in the battery 1 (the uninspected battery 1X) are prescribed as directions indicated with arrows in FIG. 1 for explanation.

A case surface 10S of the almost rectangular parallel-piped battery case 10 is roughly divided into six parts of a first long-side surface 11A, a second long-side surface 11B, a first short-side surface 11C, a second short-side surface 11D, and a bottom surface 11E which constitute the case body 11, and the lid member 12 (see FIG. 1). Among these, the first long-side surface 11A and the second long-side surface 11B extend in the width direction CR and the height direction DH and face each other in the thickness direction BH to be placed in parallel. Further, the first short-side surface 11C and the second short-side surface 11D extend in the thickness direction BH and the height direction DH and face each other in the width direction CH to be placed in parallel so as to join the first long-side surface 11A and the second long-side surface 11B. Further, the bottom surface 11E and the lid member 12 extend in the thickness direction BH and the width direction CH and face the height direction DH to close a rectangular cylinder configured with the first long-side surface 11A, the second long-side surface 11B, the first short-side surface 11C and the second short-side surface I ID.

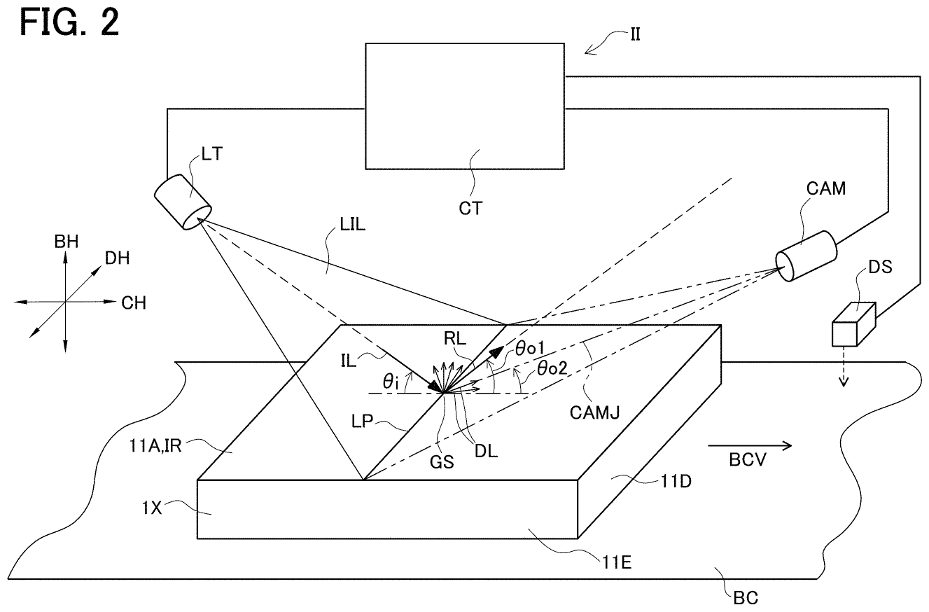

Next, a method of performing an appearance inspection of the uninspected. battery 1X (the battery case 10) is explained with reference to FIG. 2. FIG. 2 illustrates a case of inspecting an appearance of the entire first long-side surface 11A as a to-be-inspected region IR of the case surface 10S of the battery case 10 which exteriorly forms the uninspected battery 1X by use of a conveyer BC and an inspection device 11. The uninspected battery 1X is placed on the conveyer BC with facing its first long-side surface 1A upward and conveyed toward a right side in the figure at a constant transferring speed BCV.

The inspection device II includes a line light source LT, a photographing portion CAM, a transfer detection portion DS, and a controller CT. Among these components, the transfer detection portion DS is to detect the transferring speed BCV of the conveyer BC.

Further, the line light source LT irradiates an inspection line light LIL as a laser beam, which has been processed to make an irradiation portion of a linear shape, on the to-be-inspected region IR (the first long-side surface 11A that is transferred by the conveyer BC in FIG. 2). Thereby, an almost linear irradiation portion LP irradiated with the inspection line light LIL extending in the height direction DH is generated on the first long side surface 11A as the to-be-inspected region IR. Then, the inspection line light LIL irradiated on the irradiation portion LP at an incident angle θi generates a specular reflection light RL emitted at an emergence angle θo (=θi) equal to the incident angle 0i from the irradiation portion LP and also generates diffuse reflection lights DL emitted in various directions.

When an image of the irradiation portion LP is to be photographed by the photographing portion CAM, a photographing angle θo2 of an optical axis CAM.' of the photographing portion CAM is made to be different from the emergence angle θo1 (θo2≠θo1) and the images of the irradiation portion LP is photographed at each predetermined time by use of the diffuse reflection lights DL emitted from the irradiation portion LP. The photographing portion CAM is a camera to photograph an image of the diffuse reflection lights DL of the inspection line light LIL irradiated on the irradiation portion LP of the to-be-inspected region IR.

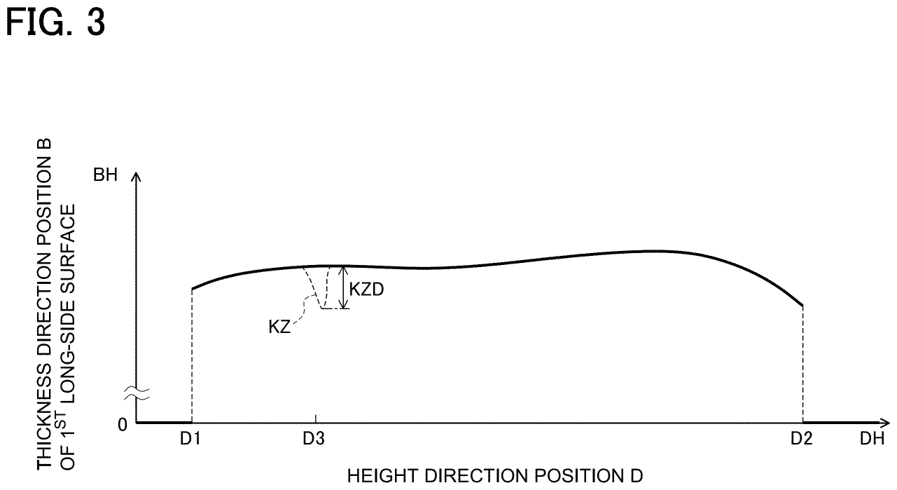

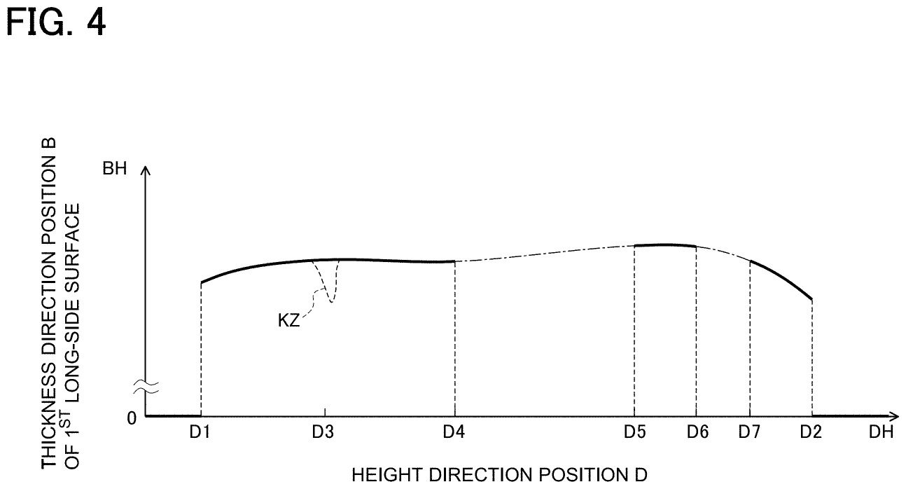

The controller CT is to calculate the appearance data (he appearance profile, see FIG. 3 and FIG. 4) indicating an outer shape of the irradiation portion LP irradiated with the inspection line light LIL in the to-be-inspected region IR from image data of the photographing portion CAM by a. known light-plane-intersecting method.

As mentioned above, the uninspected battery 1X is placed and transferred by the conveyer BC, and thus the irradiation portion LP moves as time goes by, so that the entire to-be-inspected region IR (for example, the first long-side surface 11A in FIG. 2) can be photographed by the photographing portion CAM and the appearance data can be obtained. For example, when the first long-side surface 11A is the to-be-inspected region IR as shown in FIG. 2, a value (height data in the thickness direction BH) at a thickness direction position B of the first long-side surface 11A can be obtained as the appearance data (the appearance profile) in a range of D1 to D2 of a height direction position D (a position in the height direction DH) where the first long-side surface 11A exists as indicated in FIG. 3.

Herein, when the battery 1 is a normal battery with no flaws or others, the value of the thickness direction position B corresponding to the height direction position D smoothly changes as exemplified with the thickness direction position B (the appearance data and the appearance profile) indicated with a bold solid line in FIG. 3. On the other hand, when the to-be-inspected region IR has the flaw, as indicated with a broken line in FIG. 3, the height suddenly changes at a point of a flaw KZ, so that presence or absence of the flaw KZ and a flaw depth KZD can be detected. As mentioned above, over the entire to-be-inspected region IR of the battery 1, the appearance (bulges and dents, presence or absence of flaws, dimension of the flaws, and others) can be inspected.

However, there are failure cases that the appearance cannot be inspected appropriately as a case contrary to the above-mentioned case. For example, in a range of D4 to D5 and D6 to D7 of the height direction position D indicated with thin chain-dot lines in FIG. 4, the value of the thickness direction position B cannot be appropriately obtained (for example, the value of the thickness direction position B cannot be obtained (cannot be calculated) due to detection failure, or the value of the thickness direction position B becomes 0 or the maximum value). Accordingly, there are cases that the appearance of the uninspected batten 1X cannot be appropriately detected. This portion (a difficult-to-detect region HE which will be explained below, a range of D4 to D5 and D6 to D7 of the height direction position D in FIG. 4) has high glossiness GS and the luminous intensity of the specular reflection light RL is increased, but the luminous intensity' of the diffuse reflection light DL becomes too small, thus failing to obtain the image of the diffuse reflection light DL by the photographing portion CAM in an appropriate manner. Accordingly, the appropriate appearance data (for example, the appropriate value at the thickness direction position B in FIG. 4) cannot be obtained.

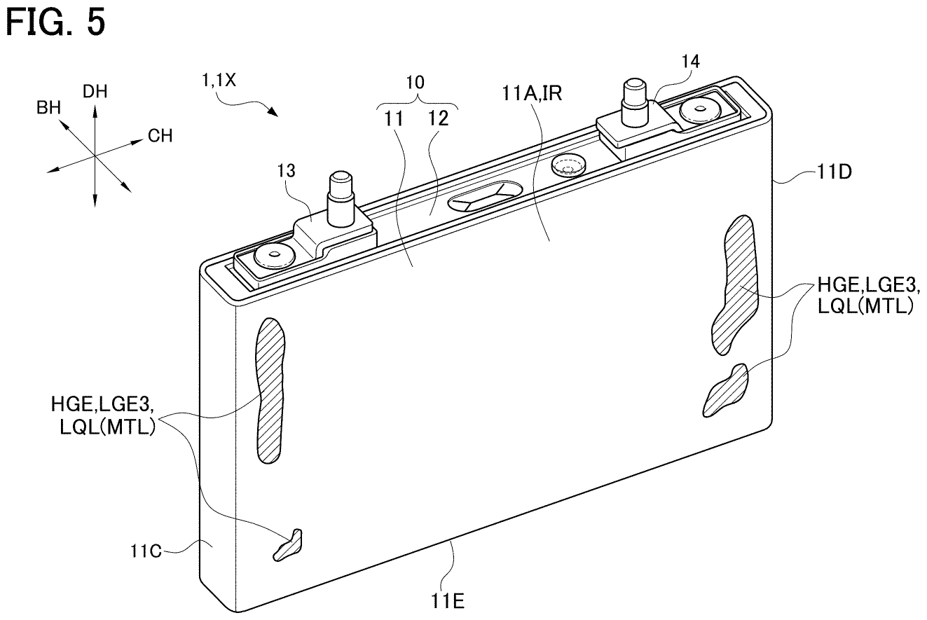

In other words, by the line light source LT emitting the inspection line light LIL and the photographing portion CAM the inspection device II used in the present embodiment shown in FIG. 2, the appropriate appearance data (such as a value at the thickness direction position B) in the difficult-to-detect region HGE that has high glossiness GS in the to-he-inspected region IR cannot be obtained, and thus the appearance cannot be appropriately inspected (see FIG. 5).

Herein, as indicated in FIG. 5 in a hatched part surrounded with a solid line, for example, the above-mentioned difficult-to-detect region HGE is often generated in parts of the first long-side surface 11A close to the first short-side surface 11C and the second short-side surface 11D. In case of producing the case body 11 by drawing process, it is considered that the case body 11 is strongly rubbed against a surface of a metal die (not shown) and formed, thereby the surface of the case body 11 vets smoothened to have high glossiness.

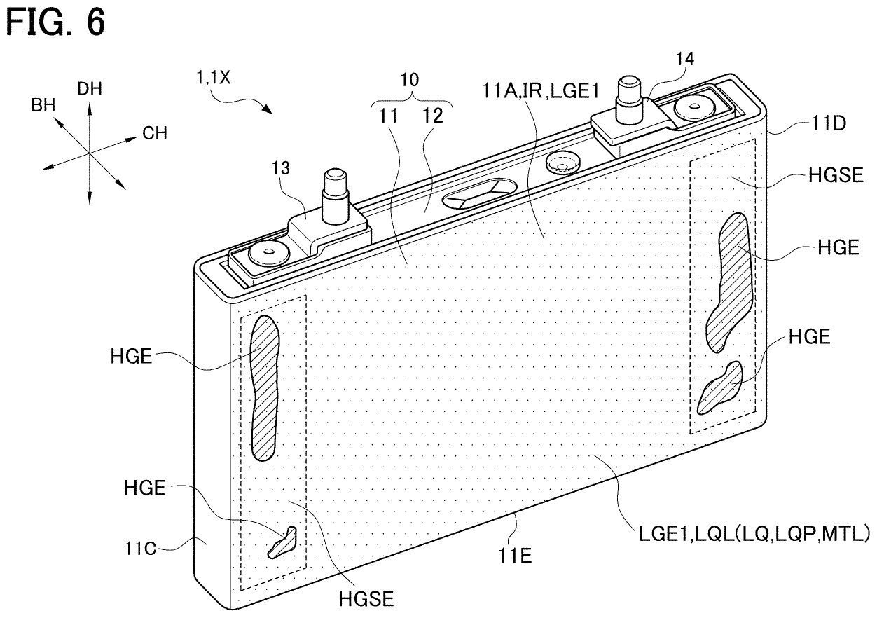

However, this difficult-to-detect region HGE is not always generated. (necessarily generated) in all the case bodies 11 produced by the same metal die. Further, a figure (a shape and a size) and a location of the venerated difficult-to-detect region HE are not always the same. As for the first long-side surface 11A, for example, in the case body 11 of the present embodiment, it has been confirmed that the difficult-to-detect region HGE is often generated inside possible difficult-to-detect regions HGSE surrounded by broken lines in FIG. 6 close to the first short-side surface 11C and the second short-side surface 11D. Further, it has also been confirmed that the difficult-to-detect region HGE is gradually generated as the metal die used for the drawing process of the case body 11 gets abraded in use. Namely, the possible difficult-to-detect region HGSE is a region that has a possibility of becoming the difficult-to-detect region HGE in the to-be-inspected region IR.

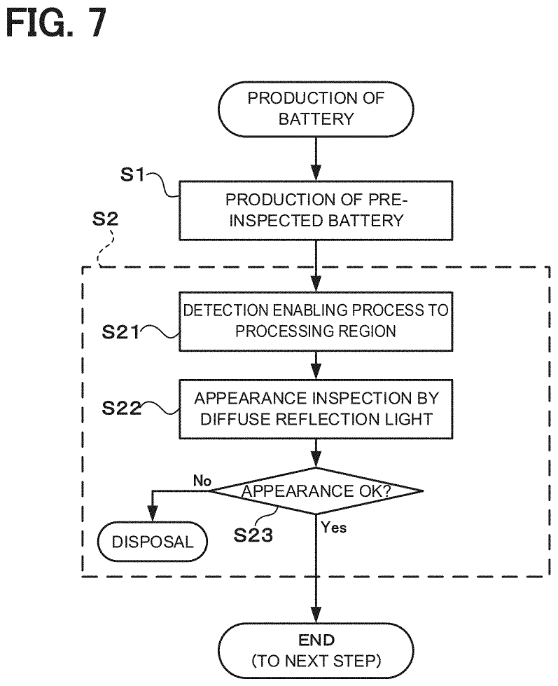

In the present embodiment, the battery 1 adopting the case body 11 that has possibility of generating the above-mentioned difficult-to-detect region HGE, namely, that includes the possible difficult-to-detect region HGSE is produced as mentioned below (see FIG. 7).

Firstly, in an uninspected battery producing step S1, the uninspected battery 1X is produced by a well-known method. A detailed explanation about producing of the uninspected battery 1X is omitted in the present embodiment.

The producing step S1 of the uninspected battery 1X may include a process of forming the uninspected battery 1X by a method of housing a not-shown electrode body to the case body 11 and laser-welding the case body 11 with the lid member 12, and may further include characteristics testing step such as an initial charging step, high-temperature aging step, and an insulation testing step. Specifically, after formation of the uninspected battery 1X, the uninspected battery 1X performed with the characteristics testing step and others is produced, and thereafter, the process may proceed to a battery appearance inspection step S2 mentioned below. Alternatively, after formation of the uninspected battery 1X and completion of the uninspected battery producing step S1, the process may proceed to the battery appearance inspection step S2, and thereafter, the characteristics testing step such as the initial charging step, the high-temperature aging step, and the insulation testing step may be carried out.

Subsequently, the thus produced uninspected battery 1X is performed with the battery appearance inspection step S2 as surrounded by a broken line in FIG. 7. This battery appearance inspection step S2 in the present embodiment carries out the appearance inspection for the to-be-inspected region IR by use of the above-mentioned inspection device II (see FIG. 2).

To be specific, in a detection enabling step S21, a detection enabling process is firstly applied. Namely, a glossiness GS of a processing region LGE1 is made to be the glossiness GS that enables detection of the appearance by the inspection device II by use of the diffuse reflection lights DL temporarily at least until performing a detection step S22 or permanently so that the processing region LGE1 can be performed with the appearance inspection. In the present embodiment, without specifying presence or absence, the location, and the shape of the difficult-to-detection region HGE of the to-be-inspected region IR, the entire to-be-inspected region IR (for example, the entire first long-side surface 11A when the entire first long-side surface 11A is defined as the to-be-inspected region IR as shown in FIG. 2) is prescribed as the processing region LGE1, and the entire processing region LGE1 is applied with the detection enabling process (see FIG. 6).

Subsequently, in the detection step S22, the appearance data (the appearance profile) of the entire to-be-inspected region IR (for example, the entire first long-side surface 11A) is detected by the diffuse reflection lights DL. To be more specific, the conveyer BC is driven so that the inspection line light LIL is successively irradiated on the entire to-be-inspected region IR (for example, the entire first long-side surface 11A in FIG. 2) to obtain the appearance data (see FIG. 3) of the entire to-be-inspected region IR so that the appearance (profiles of bulges or dents, presence or absence of flaws, and others) of the entire to-be-inspected region IR is detected.

At this time, the entire part of the to-be-inspected region IR has been processed with the detection enabling process, and thus any part of the to-be-inspected region IR can be appropriately performed with the appearance inspection irrespective of presence or absence of generation of the difficult-to-detect region HGE in the to-be-inspected region IR. In other words, even if a part of the to-be-inspected region IR becomes the difficult-to-detect region HGE (for example, as shown in FIG. 6, even if a part of the first long-side surface 11A becomes the difficult-to-detect region HGE indicated with hatching), the processing region LGE1 including this difficult-to-detect region HGE and also the possible difficult-to-detect region HGSE indicated with the broken line (in the present embodiment, the entire to-be-inspected region IR) have been processed with the detection enabling process, and thus any part of the to-be-inspected region IR can be appropriately performed with the appearance inspection.

Subsequently, in a determination step S23, propriety of the appearance of the to-be-inspected region IR is determined based on a detection result of the detection step S22, and when the determination result is unfavorable (No), the subject battery 1 is disposed of. On the other hand, when the appearance of the to-be-inspected region IR is determined to be favorable (Yes), the producing process of the battery 1 is terminated or proceeds to further steps as mentioned above.

Accordingly, the appearance of the entire to-be-inspected region FR can be appropriately detected, and further, the battery 1 that has been appropriately inspected its appearance can be produced.

The above explanation has been made with a case of only examining the first long-side surface 11A. When the appearance inspection is to be performed for five faces constituting the case body 11 (the first long-side surface 11A, the second long-side surface 11B, the first short-side surface 11C, the second short-side surface 11D, and the bottom surface 11E) or for six faces constituting the battery case 10 (the above-mentioned five faces and the lid member 12), steps corresponding to the steps S21 to S23 may be repeated for other faces after the determination step S23 so as to produce only the battery 1 that has preferable results in the appearance inspection for all the inspected faces or to proceed further to the following steps.

Further in the present embodiment, the detection enabling process to be applied to the processing region LGE1 in the detection enabling step S21 is specifically to generate a minute-droplets distributed layer LQL, in which minute droplets LQP formed of volatile liquid LQ are dispersedly distributed, in the processing region LGE1 of the case surface 10S. To be more specific, cooling gas made of liquefied gas such as liquefied propane or made of high-pressure gas is blown off to the processing region LGE1 to cool down the processing region LGE1 so that the minute-droplets distributed layer in which minute droplets are dispersedly distributed by dew condensation is generated. When the minute-droplets distributed layer (a minute-water-droplets distributed layer) LQL is generated by blowing off the cooling gas to cause dew condensation, droplets LQP forming the minute-droplets distributed layer (the minute-water-droplets distributed layer) can be easily volatilized (evaporated) by leaving it alone and raising of temperature thereafter, so that the droplets LQP do not remain on the case surface 10S of the battery case 10, and thus the droplets LQP leave no influence on the appearance of the battery 1 and handling of the battery 1 thereafter.

As a method of generating the minute-droplets distributed layer LQL in the processing region LGE1, there may be adopted a method of spraying volatile liquid LQ such as water, methanol, and Fluorinert™ in a mist shape to the processing region LGE1 to generate the minute-droplets distributed layer LQL in which the minute droplets LQP of these liquid LQ are dispersedly distributed. In this case, too, the minute droplets LQP easily forming the minute droplets distributed layer LQL do not remain on the case surface 10S of the battery case 10, thus having no influence on the appearance of the battery 1 and the handling thereafter.

Other than the above, as the detection enabling process applied to the processing region LGE1 in the detection enabling step S21, a matted material layer MTL may be formed instead of the minute-droplets distributed layer LQL. As a method of forming this matted material layer MTL, there may be a method of spraying and applying matte paint to the processing region LGE1 by an air spray or the like and a method of blowing dispersion liquid in which fine powder of zinc oxide powder or the like is dispersed in volatile solution dissolved with a binder to deposit the fine powder. Also by those methods, the entire to-be-inspected region IR can be appropriately detected its appearance in the detection step S22, and the propriety of the appearance of the to-be-inspected region IR can be appropriately determined.

Alternatively, as the detection enabling process to be applied to the processing region LGE1 in the detection enabling step S21, a roughening processing of roughening the processing region LGE1 may be performed instead of forming the minute-droplets distributed layer LQL. As the method of roughening, there are grinding of generating friction marks by grinding the processing region LGE1 with a sponge containing abrasive material and blasting of making the surface of the processing region LGE1 by blowing off sands. Also by these methods, the entire to-be-inspected region IR can be appropriately detected its appearance in the detection step S22, and thus propriety of the appearance of the to-be-inspected region IR can be appropriately determined.

### First Modified Embodiment

The above-mentioned embodiment is illustrated with an example of the processing region LGE1 as the entire to-be-inspected region IR (the entire first long-side surface 11A) for performing the detection enabling process to the processing region LGE1 in the detection enabling step S21 (see FIG. 6).

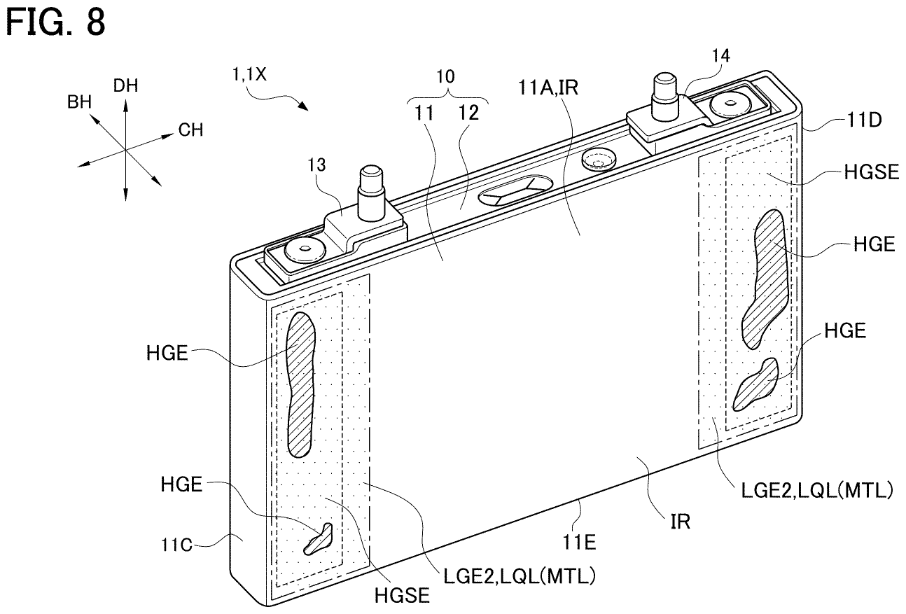

However, the entire to-be-inspected region IR does not have to be the processing region, and the processing region only has to include at least the entire possible difficult-to-detect region HGSE that has a possibility of becoming the difficult-to-detect region HGE. Accordingly, in the present first modified embodiment, when the detection enabling process is to be applied to a processing region LGE2 in the detection enabling step S21 (see FIG. 7) in the producing step of the battery 1, a range of this processing region LGE2 is prescribed as a part of the to-be-inspected region IR (the entire first long-side surface 11A) as surrounded by a chain-dot line in FIG. 8 such that the entire possible difficult-to-detect region HGSE surrounded by a broken line is included.

Thus, also by the producing method of the first modified embodiment, a range which has the possibility of generating the difficult-to-detect region HGE, namely, the entire possible difficult-to-detect region HGSE can be performed with the detection enabling process. Therefore, the appearance of the entire to-be-inspected region IR can be appropriately detected, and further the battery 1 that has been appropriately inspected its appearance can be produced irrespective of presence or absence of the difficult-to-detect region HGE.

As a specific method of the detection enabling process, every method indicated in the embodiment such as blowing of the cooling gas may be adopted in the first modified embodiment, too.

### Second Modified Embodiment

The embodiment and the first modified embodiment exemplify performing the detection enabling process to the processing regions LGE1 and LGE2 in the detection enabling step S21 without specifying presence or absence of the difficult-to-detect region HGE of the to-be-inspected region IR and specific location or shape of the difficult-to-detect region HGE (see FIG. 6 to FIG. 8).

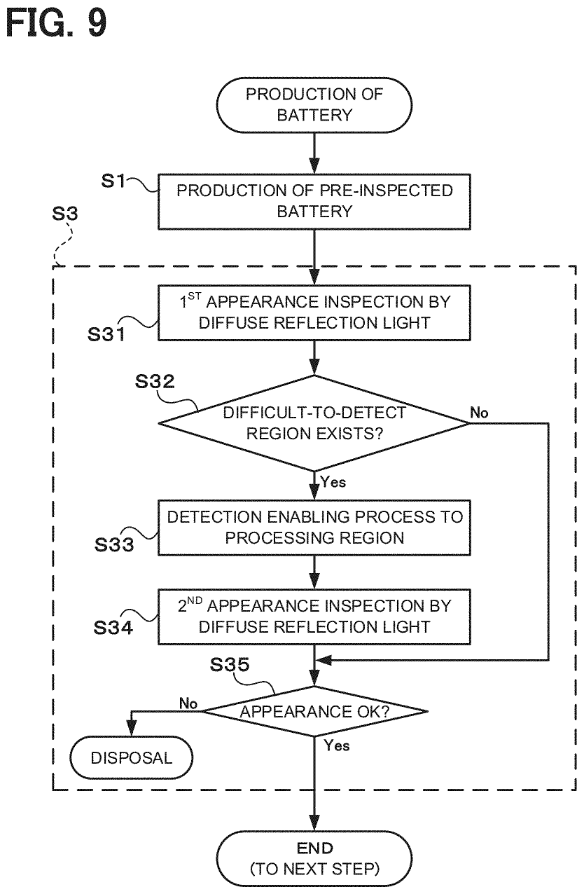

However, in advance of performing the detection enabling process in the detection enabling step, the presence or absence of the difficult-to-detect region HGE in the to-be-inspected region IR may be detected, and when the difficult-to-detect region FIGE exists, the specific location or the shape of the region HGE may be specified and the detection enabling process may be carried out in a region including the thus specified difficult-to-detect region HGE. In the present second modified embodiment, too, the uninspected battery 1X is firstly produced by a well-known method in the producing step S1 of the uninspected battery 1X (see FIG. 9).

Subsequently, the produced uninspected battery 1X is performed with the battery appearance inspection step S3 surrounded by a broken line in FIG. 9. Also in this battery appearance inspection step S3 in the second modified embodiment, the appearance inspection for the to-be-inspected region IR is performed by the above-mentioned inspection device II (see FIG. 2).

Although a process order is different from the embodiment and the first modified embodiment, firstly, in a first detection step S31 as similar to the detection step S22 in the embodiment, the appearance (bulges or dents, presence or absence of flaws) of the entire to-be-inspected region IR (for example, the entire first long-side surface 11A) is detected by the diffuse reflection lights DL.

Subsequently, in a difficult-to-detect region presence determination step S32, it is determined whether the appearance data (the appearance profile) has been appropriately obtained depending on presence or absence of the difficult-to-detect region HGE in the first detection step S31. in other words, it is determined whether the appearance data (the appearance profile) could not appropriately be obtained since there exists the difficult-to-detect region. When a determination result is negative, namely, when there is no difficult-to-detect region HGE existing in the to-be-inspected region IR and the entire to-be-inspected region IR could be appropriately detected with the appearance data (the appearance profile), the process proceeds to the determination step S35.

On the other hand, when the determination result of the difficult-to-detect region presence determination step S32 is affirmative (Yes), namely, the difficult-to-detect region HGE exists and thereby a part of the to-be inspected region IR failed to be obtained with the appearance data. in an appropriate manner, the process proceeds to the detection enabling step S33. Herein, an area (the location and the shape) of the difficult-to-detect region HGE can be specified from the appearance data obtained in the first detection step S31.

In the detection enabling step S33, an area including the specified difficult-to-detect region HGE is prescribed as a processing region LGE3, and this processing region LGE including the difficult-to-detect region HGE is applied with the detection enabling process. Specifically, the minute-droplets distributed layer (or the matted material layer MTL) is formed. Alternatively, a surface of the processing region LGE3 is roughened.

Thereafter, in a second detection step S34, the entire to-be-inspected region IR (for example, the entire first long-side surface 11A) is detected again by use of the diffuse reflection lights DL as similar to the first detection step S31 to detect the appearance (the bulges and the dents, and presence or absence of the flaws).

In this second detection step S34, irrespective of generation of the difficult-to-detect region HGE in the to-be-inspected region IR, the processing region LGE3 has been applied with the detection enabling process, so that the entire to-be-inspected region IR can be appropriately detected its appearance.

Accordingly, in the determination step S35, propriety of the appearance of the to-be-inspected region IR is determined based on the detection result of the first detection step S31 or the second detection step S34. When the appearance is determined to be defective (No), the subject battery 1 is disposed or dealt with other ways, On the other hand, when the appearance of the to-be-inspected region IR is determined to be favorable (Yes), the producing process of the battery 1 is terminated. Alternatively, further following steps are proceeded as mentioned above.

The appearance of the entire to-be-inspected region IR can be thus appropriately detected, and moreover, the battery 1 which is appropriately inspected its appearance can be produced.

Furthermore, in the producing method of the second modified embodiment, only the uninspected battery 1X including the difficult-to-detect region HGE is performed with the detection enabling step S33 and the second detection step S34, achieving reduction in cost and time for gas, paints, and others for a glossiness reduction process.

The present disclosure has been explained above with the embodiment and the first and second modified embodiments, but the present disclosure is not limited to the above embodiments and may be applied with any modifications without departing from the scope of the disclosure.

For example, in the second modified embodiment, when the difficult-to-detect region HGE exists, only the appearance data (the appearance profile) obtained in the second detection step S34 is used in the determination step S35. Alternatively, both the appearance data obtained in the first detection step S31 and the appearance data obtained in the second detection step S34 may be used. Further alternatively, of the appearance data obtained in the first detection step S31, the region that could not be appropriately obtained (corresponding to the difficult-to-detect region HGE) can be complemented with the appearance data obtained in the second detection step S34. In this case, only the region including the one that could not be appropriately obtained (corresponding to the difficult-to-detect region HGE) of the to-be-inspected region IR may be performed with the second appearance inspection in the second detection step S34 so that a period of time for inspection is shortened.

Further, in the second modified embodiment, the appearance data is detected in the first detection step S31 to detect presence or absence of the difficult-to-detect region HGE, and the uninspected battery 1X having the difficult-to-detect region HGE is performed with the detection enabling step S33 and then similarly obtained with the appearance data in the second detection step S34, too. Alternatively, instead of the first detection step S31, there may be provided a step of detecting presence or absence of the difficult-to-detect region HGE by measuring glossiness of each part of the to-be-inspected region IR by use of a glossmeter. The uninspected battery 1X having the difficult-to-detect region HGE has thus gone through the detection enabling step so that all the uninspected batteries TX may be obtained their appearance data by use of the diffuse reflection lights in the detection step.

### REFERENCE SIGNS LIST

1 Battery (Power storage device)

1X Uninspected battery (Uninspected power storage device)

10 Battery case (Device case)

10S Case surface (of the battery case)

IR To-be-inspected region (of the case surface)

HGE Difficult-to-detect region (of the to-be-inspected region)

HGSE Possible difficult-to-detect region (of the to-be-inspected region)

LGE1, LGE2, LGE3 Processing region

11 Case body

11A First long-side surface

LIL Inspection line light (Inspection light)

DL Diffuse reflection light

LP Irradiation portion (which is irradiated with the inspection line light)

CAM Photographing portion

GS Glossiness

θo2 Photographing angle (of the photographing portion)

S1 Producing step of the uninspected battery (Producing step of the uninspected power storage device)

S2, S3 Battery appearance inspection step (Appearance inspection step of the uninspected power storage device)

S21 Detection enabling step

S22 Detection step

S23 Determination step

S31 First detection step

S32 Difficult-to-detect region presence determination step

S33 Detection enabling step

S34 Second detection step

S35 Determination step

LQ Liquid

LQP Minute droplets

LQL Minute-droplets distributed layer

MTL Matted material layer

What is claimed is:

1. A producing method of a power storage device exteriorly formed with a device case, including:
producing an uninspected power storage device; and
appearance inspecting of inspecting the uninspected power storage device, wherein
the appearance inspecting comprises:
detecting which includes irradiating an inspection light on the to-be-inspected region, photographing diffuse reflection lights of the inspection light, and checking an appearance of the to-be-inspected region of a case surface of the device case, and
determining propriety of the detected appearance of the to-be-inspected region,
the appearance inspecting further includes detection enabling of performing a detection enabling process prior to the detecting to enable detection of the appearance on at least any one in the to-be-inspected region of the device case of:
a difficult-to-detect region which is difficult to be detected its appearance due to high glossiness; and
a possible difficult-to-detect region which has a possibility of becoming the difficult-to-detect region. The producing method of the power storage device according to claim 1, wherein the detection enabling is, as the detection enabling process, to generate a minute-droplets distributed layer, in which minute droplets formed of volatile liquid are dispersedly distributed, in any one of the difficult-to-detect region and the possible difficult-to-detect region.

3. The producing method of the power storage device according to claim 1, wherein, the detection enabling is, as the detection enabling process, to form a matted material layer in any one of the difficult-to-detect region and the possible difficult-to-detect region.

4. The producing method of the power storage device according to claim 1, wherein, the detection enabling is, as the detection enabling process, to apply roughening to any one of the difficult-to-detect region and the possible difficult-to-detect region.
